(19) United States
(12) Patent Application Publication
(10) Pub. No.: US 2004/0090140 A1
(43) Pub. Date: May 13, 2004

(54) Axial-gap motor

(76) Inventors: Emil Nai Hong Lai, Tokyo (JP); Akiko Aw, Tokyo (JP); Kazuhiro Nagai, Tokyo (JP); Kazuhiro Matsuyama, Tokyo (JP); Atsushi Matsuyama, Tokyo (JP)

Correspondence Address: FISH & RICHARDSON PC, 225 FRANKLIN ST, BOSTON, MA, 02110, US

(21) Appl. No.: 10/698,315

(22) Filed: Oct. 31, 2003

Related U.S. Application Data
(63) Continuation of application No. PCT/JP03/01027, filed on Jan. 31, 2003.

(30) Foreign Application Priority Data
Feb. 1, 2002 (WO) PCT/JP02/00846

(51) Int. Cl. H02K 21/12; H02K 1/22

(52) U.S. Cl. 310/268; 310/156.37

(57) ABSTRACT

An axial-gap motor comprising a base, a shaft, a stator frame, a plurality of electromagnet units, bearings, a rotor frame, and a plurality of permanent magnet units, an rotary encoder, and a drive unit. The rotor frame is spaced from the stator frame by a predetermined distance. The permanent magnet units oppose the electromagnet units across a predetermined axial gap. From the output of the rotary encoder, the drive unit supplies an excitation current to the electromagnet units, causing the magnetic poles of the units to repulse those of the permanent magnet units. The magnetic-field centerline that passes the center of each electromagnet unit intersects, at a predetermined angle, with the magnetic-field centerline that passes the center of one permanent magnet unit.

### CROSS-REFERENCE TO RELATED APPLICATIONS

This is a Continuation Application of PCT Application No. PCT/JP03/01027, filed Jan. 31, 2003, which was not published under PCT Article 21(2) in English, and which is based upon and claims the benefit of priority from the prior PCT Application No. PCT/JP02/00846, filed Feb. 1, 2002, the entire contents of the two PCT applications being incorporated herein by reference.

### BACKGROUND OF THE INVENTION

1. Field of the Invention

The present invention relates to an axial-gap motor in which the rotor spaced from the stator, with an axial gap, is rotated by utilizing electromagnetic repulsion.

2. Description of the Related Art

Axial-gap motors are known, in which a gap exists in the axial direction.

Many types of axial-gap motors have hitherto been manufactured, which have permanent magnet units and no brushes.

Such an electric motor can save energy because it has permanent magnet units. Having no brushes, it is maintenance-free

In an electric motor of this type, the rotation torque is acquired usually from a rotating magnetic field generated between the rotor and the stator. Hence, a rotating magnetic field should be generated, though the motor has a permanent magnet unit. In view of this, a key to the energy saving in the electric motor is to reduce the energy required to generate the turning magnetic field.

### BRIEF SUMMARY OF THE INVENTION

An object of the present invention is to provide an axial-gap motor that can save energy.

To attain the object, an axial-gap motor according to this invention comprises:

a stator frame;

a plurality of electromagnet units which are arranged on the stator frame;

a rotor frame which is spaced apart from the stator frame by a predetermined distance;

a plurality of permanent magnet units which are provided on the rotor frame, which oppose the electromagnet units across an axial gap and each of which has a magnetic-field centerline that intersects with a magnetic-field centerline of the electromagnet unit as viewed in a radial direction;

a sensor unit which detects a positional relation of the electromagnet units and permanent magnet units; and

a drive unit which detects, from an output of the sensor unit, that each of the permanent magnet units has rotated by a predetermined angle from the position where magnetic poles of the permanent magnet units substantially opposes magnetic poles of the electromagnet units and which supplies an excitation current to the electromagnet units, so as to repulse the magnetic poles of the permanent magnet units and the magnetic poles of the electromagnet units, through the predetermined angle.

In the motor thus configured, the electromagnet units and the permanent magnet units are so arranged that the magnetic-field centerline of each electromagnet unit intersects with the magnetic-field centerline of one permanent magnet unit, at the predetermined angle. Each permanent magnet unit is therefore rotated by a predetermined angle from the position where the magnetic poles of the permanent magnet units substantially opposes that of the electromagnet units. The excitation current is then supplied to the electromagnet units. The magnetic poles of the permanent magnet units repulse the magnetic poles of the electromagnet units, through the predetermined angle.

In the axial-gap motor, when θ11+θ12+θ13)/number of poles of the rotor=360°, the drive unit may preferably comprise means for supplying the excitation current to the electromagnet units in accordance with the output of the sensor unit such that θ11 is a period in which the permanent magnet units remain close to the electromagnet units and the excitation current is not supplied, θ12 is a period in which the magnetic fields of the electromagnet units repel the magnetic fields of the permanent magnet units and the excitation current is supplied, and θ13 is a period in which the excitation current is not supplied.

In the axial-gap motor described above, when θ21+θ22+θ23 +θ24)/number of poles of the rotor=360°, the drive unit may preferably comprise means for supplying the excitation current to the electromagnet units in accordance with the output of the sensor unit such that θ21 is a period in which the permanent magnet units remain close to the electromagnet units and the excitation current is not supplied, θ22 is a period in which the electromagnet units magnetically repulse the permanent magnet units and the excitation current is supplied, θ23 is a period in which the excitation current is not supplied, and θ24 is a period in which the electromagnet units magnetically attract the permanent magnet units and the excitation current is supplied.

In the axial-gap motor described above, each of the electromagnet units may preferably has a magnetic-pole surface each which is orientated in an axial direction.

In the axial-gap motor described above, the electromagnet units may preferably be arranged on the stator frame and spaced apart at regular intervals, irregular intervals, or regular and irregular intervals in a circumferential direction.

In the axial-gap motor described above, the electromagnet units may preferably be arranged on the stator frame in one or more stages in the radial direction.

In the axial-gap motor described above, each of the electromagnet units may preferably comprise at least one of an I-shaped core and a U-shaped core and a coil wound around the at least one of the cores.

In the axial-gap motor described above, each of the electromagnet units may preferably comprise a C-shaped yoke having a gap in which one permanent magnet unit on the rotor frame is arranged, and coils wound around the end portions of the yoke, respectively.

In the axial-gap motor described above, each of the electromagnet units may preferably comprise a plurality of C-shaped yokes provided on one side of the stator frame and straddling one permanent magnet unit on the rotor frame, a plurality of C-shaped yokes provided on the other side of the rotor frame and straddling the permanent magnet unit on the rotor frame, and coils wound around end portions of each of these yokes.

In the axial-gap motor described above, each of the electromagnet units may preferably comprise a first yoke arranged on one side of the stator frame, straddling one permanent magnet unit on the rotor frame and having one end opposing the permanent magnet unit on the stator frame, and a second yoke arranged on the other side of the stator frame, straddling the permanent magnet unit on the rotor frame and having one end opposing the permanent magnet unit on the stator frame.

In the axial-gap motor described above, the rotor frame may preferably have a wall opposing the stator frame and a plurality of grooves made in the wall, extending in the radial direction and provided for holding the permanent magnet units.

In the axial-gap motor described above, each of the permanent magnet units may preferably have a magnetic-pole surface which is orientated in an axial direction.

In the axial-gap motor described above, the permanent magnets may preferably be arranged on the rotor frame in a circumferential direction, with adjacent magnetic poles having the same polarity, different polarity or the same polarity and different polarities and spaced apart at regular intervals, irregular intervals or regular and irregular intervals.

In the axial-gap motor described above, the permanent magnets may be preferably arranged on the rotor frame in a circumferential direction and in one or more stages, with adjacent magnetic poles having the same polarity, different polarity or the same polarity and different polarities.

In the axial-gap motor described above, some of the permanent magnet units are arranged on one wall of the rotor frame, which extends in the axial direction, and the remaining permanent magnet units are arranged on the other wall of the rotor frame, which extends in the axial direction.

In the axial-gap motor described above, each of the permanent magnet units may preferably comprise a first permanent magnet piece arranged on one wall of the rotor frame, which extends in the axial direction, a second permanent magnet piece arranged on the other wall of the rotor frame, which extends in the axial direction, and a third permanent magnet piece arranged between the first and second permanent magnet pieces.

The axial-gap motor described above, at least one part of the rotor frame on which the permanent magnet units are provided is made of titanium.

In the axial-gap motor described above, another rotor frame may be provided on that side of the stator frame which faces away from the rotor frame, and other electromagnet units may be arranged on the other rotor frame and spaced apart from the permanent magnet units across a predetermined axial gap.

The axial-gap motor described above may preferably further comprise:

a shaft which is coupled to the rotor frame;

bearings which support the shaft; and

a base in which the bearing are provided.

In the axial-gap motor described above, a flywheel may preferably be arranged on the rotor frame.

In the axial-gap motor described above, a mechanism may preferably be provided to combine the rotor frame and the shaft together and separate the rotor frame and the shaft from each other.

In the axial-gap motor described above, a mechanism may preferably be provided to combine the rotor frame and the shaft together and separate the rotor frame and the shaft from each other.

The axial-gap motor described above may further comprise a gearbox that changes a rotational speed of the shaft.

### BRIEF DESCRIPTION OF THE SEVERAL VIEWS OF THE DRAWING

FIG. 1 is a sectional view showing an axial-gap motor that is an embodiment of this invention;

FIG. 2 is a perspective view of the embodiment;

FIG. 3 illustrates the stator section as viewed in the axial direction;

FIG. 4 depicts the rotor section as viewed in the axial direction;

FIG. 5 is a diagram showing how the magnetic-field direction of the permanent magnet units on the rotor intersects with the magnetic-field direction of the electromagnet units on the stator;

FIG. 6 is a diagram of the electric circuit incorporated in the embodiment;

FIG. 7 is a circuit diagram showing the electromagnet units used in the embodiment;

FIG. 8 is a diagram illustrating a method of exciting the electromagnet units in the embodiment;

FIG. 9 is a waveform diagram showing the excitation currents supplied to the four electromagnet units used in the embodiment;

FIG. 10 is a diagram illustrating another method of exciting the electromagnet units in the embodiment;

FIG. 11 shows a stator section of another type for use in the embodiment, as viewed in the axial direction;

FIG. 12 depicts a rotor section of another type for use in the embodiment, as viewed in the axial direction;

FIG. 13 shows a stator section of still another type for use in the embodiment, as viewed in the axial direction;

FIG. 14 shows a rotor section of still another type for use in the embodiment, as viewed in the axial direction;

FIG. 15 is a sectional view showing an axial-gap motor that is another embodiment of this invention;

FIG. 16 depicts the stator section provided in the other embodiment, as viewed in the axial direction;

FIGS. 17A to 17E show several types of electromagnet units for use in an axial-gap motor of this invention, each comprising an I-shaped core or I-shaped cores;

FIGS. 18A and 18B show two types of electromagnet units for use in an axial-gap motor of this invention, each comprising a U-shaped core or U-shaped cores;

FIG. 19 is a sectional view showing an axial-gap motor that is still another embodiment of this invention;

FIG. 20 shows an axial-gap motor that is another embodiment of the invention, illustrating how the magnetic-field direction of the permanent magnet units on the rotor intersects with the magnetic-field direction of the electromagnet units on the stator;

FIG. 21 is a sectional view depicting an axial-gap motor that is another embodiment of the present invention;

FIG. 22 illustrates the stator section as viewed in the axial direction;

FIG. 23 depicts the rotor section as viewed in the axial direction;

FIG. 24 is a diagram showing an electromagnet unit used in the axial-gap motor of this invention and having a C-shaped core;

FIG. 25 is a diagram shows how the magnetic-field direction of the permanent magnet units on the rotor intersects with the magnetic-field direction of the electromagnet units on the stator;

FIG. 26 is a diagram depicts a permanent magnet unit on the rotor, which is different from the one illustrated in FIG. 24;

FIG. 27 is a diagram illustrating a yoke for use in the electromagnet units, which is different from the one shown in FIG. 21;

FIG. 28 is a perspective view showing a part of the yoke illustrated in FIG. 27;

FIG. 29 is a diagram showing a yoke for use in the electromagnet units, which is different from the one shown in FIG. 21;

FIG. 30 is a perspective view depicting a part of the yoke shown in FIG. FIG. 29; and

FIG. 31 is a perspective view showing another type of a rotor frame.

### DETAILED DESCRIPTION OF THE INVENTION

Embodiments of the present invention will be described.

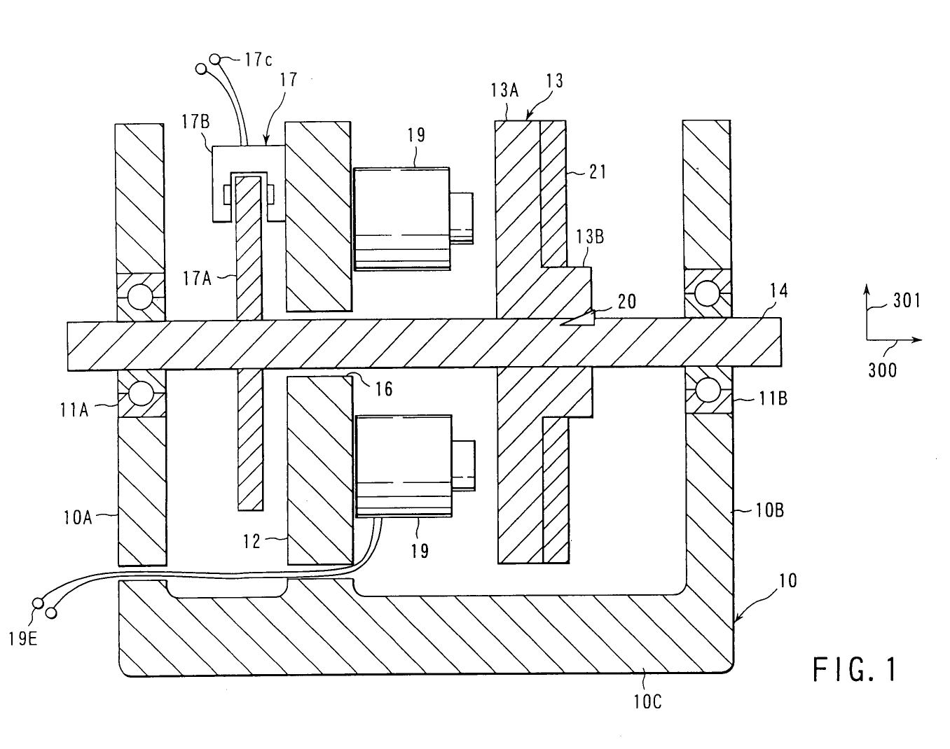

FIG. 1 is a sectional view showing an axial-gap motor according to an embodiment of this invention.

As FIG. 1 shows, the axial-gap motor according to the embodiment has a stator and a rotor that oppose each other across an axial gap. In the electric motor, each electromagnet provided on the stator acts on the same pole of the permanent magnet provide on the stator. Thus, an electromagnetic repulsion develops. The repulsion rotates the rotor and, hence, the shaft.

The axial-gap motor according to the embodiment further has a base 10, bearings 11A and 11B, a stator frame 12, a rotor frame 13, a shaft 14, a plurality of permanent magnet units 18, and a plurality of electromagnet units 19. The stator frame 12 is provided on the base 10. The electromagnet units 19 are arranged on the stator frame 12. The bearings 11A and 11B are provided in the base 10 and mounted on the shaft 14. The rotor frame 13 is mounted on the shaft 14, at midpoint in the axial direction 300. The rotor frame 13 opposes the stator frame 12 and can rotate. The permanent magnet units 18 are provided on the rotor frame 13. Each permanent magnet unit 18 opposes one electromagnet unit 19 across an axial gap.

The axial-gap motor according to the embodiment further has a rotary encoder 17 and a drive unit 22. The encoder 17 detects the positional relation between each electromagnet unit 19 and one permanent magnet unit 18. The drive unit 22 supplies an excitation current to the electromagnet unit 19. The current is based on the output of the rotary encoder 17.

In the motor thus constructed, the magnetic-field centerline passing the pole center of each electromagnet unit 19 on the stator intersects at, for example, 50° with the magnetic-field centerline passing the pole center of the permanent magnet unit 18 on the rotor.

The axial-gap motor according to this embodiment invention will be described in detail, with reference to FIGS. 1 to 4.

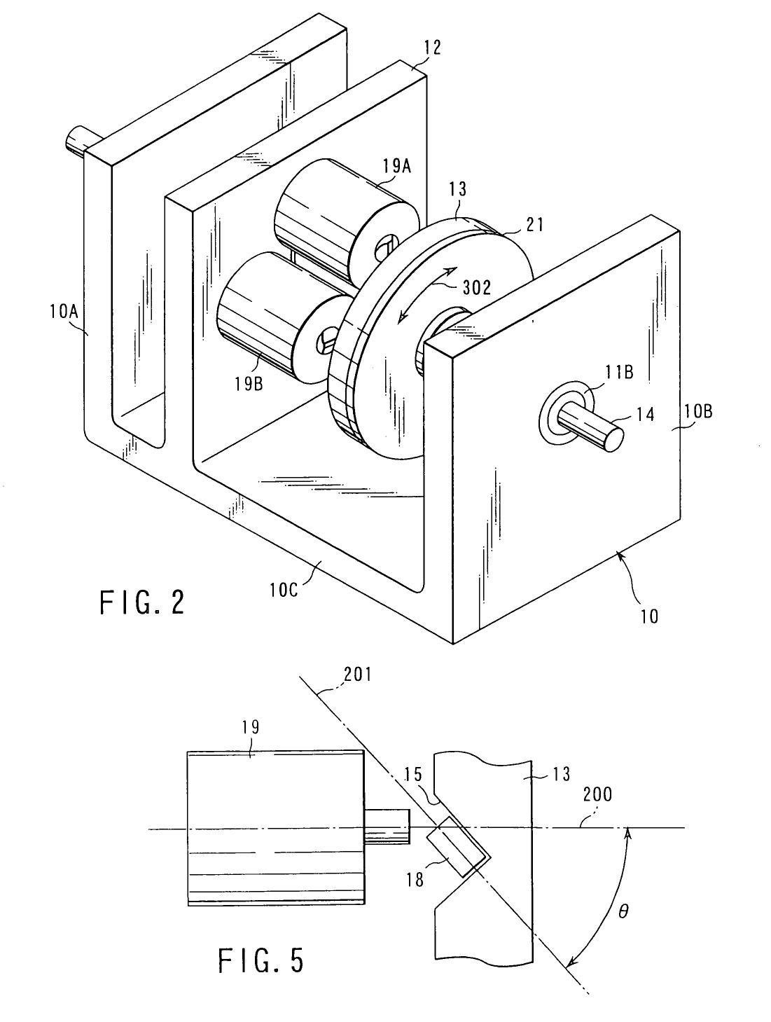

As FIGS. 1 and 2 show, the axial-gap motor according to this embodiment has the base 10. The base 10 comprises a first wall plate 10A, a second wall plate 10B, and a bottom plate 10C. The second wall 10B opposes the first wall plate 10A and spaced from the first wall plate 10A. The bottom plate 10C. connects one end of the first wall plate 10A to one end of the second wall plate 10B.

The base 10 may be a single casting or may be a three-piece component. In the latter case, it is made by welding the first wall plate 10A, second wall plate 10B and bottom plate 10C together or fastening them together with screws.

The stationary part of the bearing 11A is held in the other end portion of the first wall plate 10A. The stationary part of the bearing 11B is held in the other end portion of the second wall plate 10A.

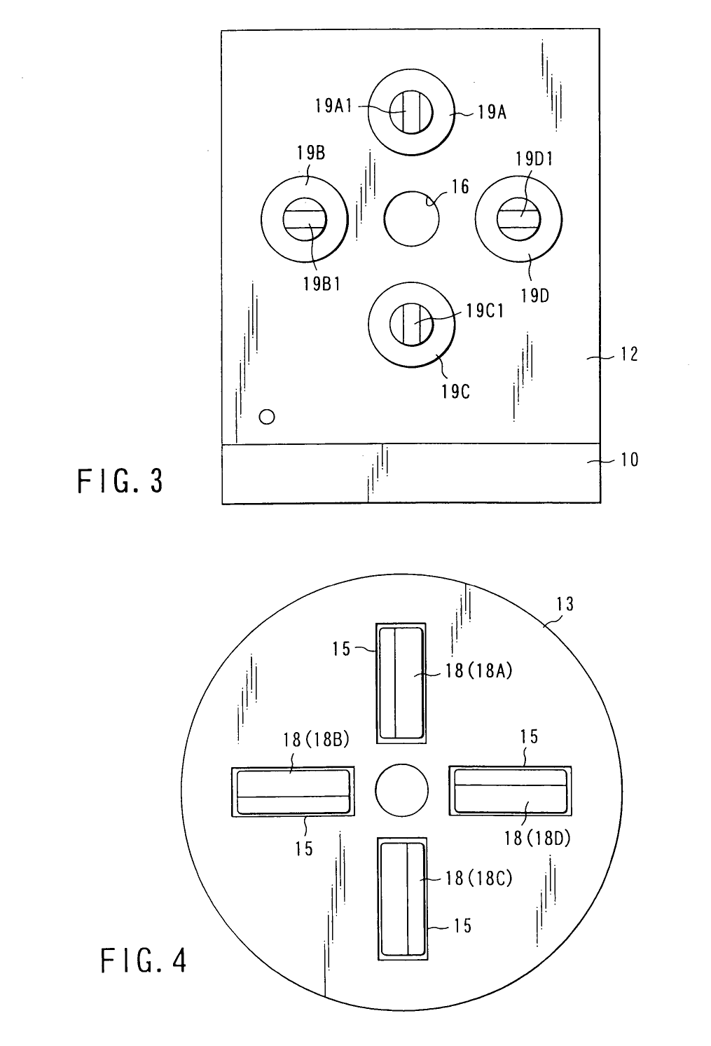

As FIG. 3 shows, the stator frame 12 has a hole 16. The stator frame 12 may be a single casting or may be made by processing a plate.

The shaft 14 passes through the rotating part of the bearing 11A and also the rotating part of the bearing 11B. Note that the bearings 11A and 11B are provided in the first wall plate 10A and the second wall plate 10B, respectively. The rotor frame 13 shown in FIG. 4 is fitted on the shaft 14, at midpoint in the axial direction 300.

A screw is driven into the interface between the rotor frame 13 and the shaft 14, fastening the frame 13 to the shaft 14.

The rotor frame 13 is thereby held, opposing the stator frame 12.

One end portion of the shaft 14 is the output shaft of the electric motor. The disk 17A of the rotary encoder 17, i.e., sensor unit, is mounted on the other end portion of the shaft 14. The rotary encoder 17 has a detecting section 17B, which is provided on the stator frame 12.

The rotary encoder 17 has a light-receiving/emitting element. This element is incorporated in the detecting section 17B. The light-receiving/emitting element detects slits or light-reflecting members provided in or on the disk 17A. The rotary encoder 17 outputs an electric signal to a read line 17C.

The rotary encoder 17 can thus detect the positional relation between the electromagnet units 19, on the one hand, and the permanent magnet unit 18, on the other. More specifically, it detects the rotational position of the rotary frame 13 and the relative positions of the magnetic poles of the permanent magnet units 18 (18A, 18B, 18C and 18D) provided on the rotor frame 13.

In the present embodiment, the permanent magnet units 18 are provided on the rotor frame 13. More precisely, they are arranged in the circumferential direction 302 and radial direction 301 such that one pole of each permanent magnet unit 18 is opposite in polarity to the adjacent pole of the next permanent magnet unit 18.

The sensor unit may not be an optical rotary encoder. It may be, for example, a Hall element. If this is the case, it can magnetically detect the positions the permanent magnet units 18 take relative to the electromagnet units 19.

As seen from FIG. 4, the rotary frame 13 is shaped like a disk. The rotary frame 13 can be a single casting or can be made by a plate.

The rotor frame 13 has grooves 15 in the side that opposes the stator frame 12. The grooves 15 are arranged in the circumferential direction at intervals of 90° (=360°/4). Each groove extends in the radial direction 301. The permanent magnet units 18 are held in the grooves.

Thus, as FIG. 4 shows, four grooves 15 are made in the rotor frame 13 and arranged in the circumferential direction. And each groove 15 extends in the radial direction 301.

The permanent magnet units 18 are held in the grooves 15. They may be secured to the rotor frame 13 by various methods, for example by using screws or resin.

The grooves 15 made in the rotor frame 13 may be so shaped to prevent the permanent magnet unit 18 from slipping out.

A mechanism may be used to change the orientation of each permanent magnet unit 18 held in one groove 15. If changed in orientation, the permanent magnet units 18 will be so positioned to apply an electromagnetic repulsion effectively act in the electric motor according to this embodiment.

The permanent magnet units 18 held in the grooves 15 may differ in shape. If so, the electromagnetic repulsion can effectively work in the electric motor according to present embodiment.

A flywheel 21 is attached to the rotor frame 13. The flywheel 21 contributes to smooth rotation of the rotor frame 13. It may not be used. Nevertheless, it should preferably be used if the number of poles is small.

The electromagnet units 19 (19A, 19B, 19C and 19D) are provided on the stator frame 12. The lead lines of the units 19 are let outwards from the base 10.

As FIG. 5 shows, the magnetic-field centerline 200 of each electromagnet unit 19 intersects at angle θ with the magnetic-field centerline 201 of the permanent magnet unit 18.

In this embodiment, the magnetic-field centerline of each electromagnet unit 19 is aligned with the axis of the shaft 14. Note that “0” is the position where the magnetic fields of the permanent magnet unit 18 and electromagnet unit 19 repel each other most effectively. The inventors hereof set 0 at, for example, 50°.

In the axial-gap motor of ordinary type, the rotor magnetic pole and the stator magnetic pole oppose each other. The embodiment is characterized in that the rotor magnetic pole and the stator magnetic pole do not oppose each other.

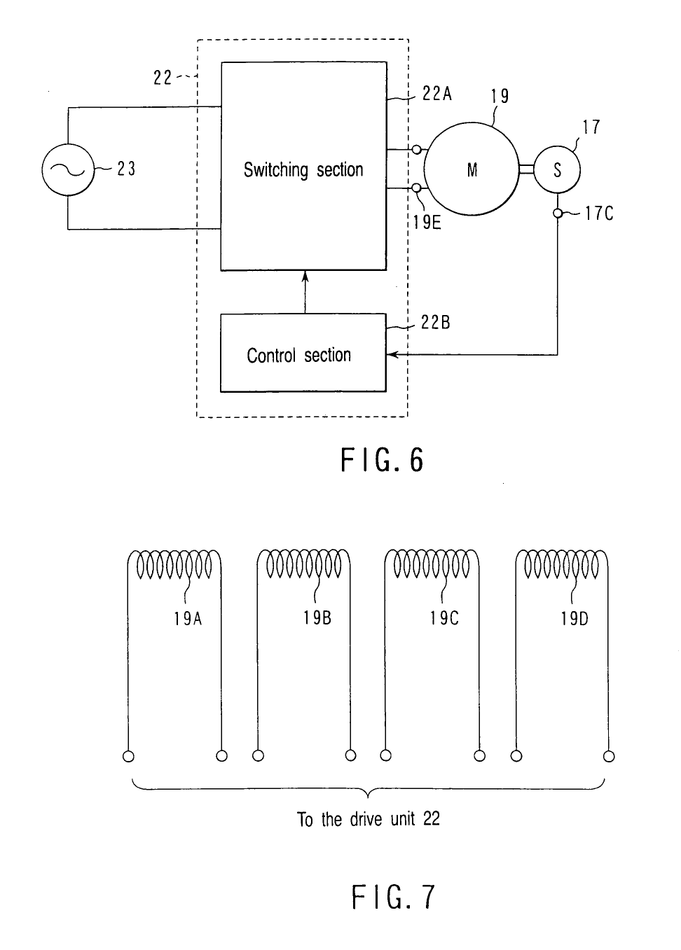

The electric system of the axial-gap motor according to this embodiment will be described with reference to FIGS. 6 to 9.

FIG. 6 is a circuit diagram of the axial-gap motor according to this embodiment. The drive unit 22 has a switching section 22A. The section 22A outputs an excitation current. The excitation current drives the electromagnet units 19.

The switching section 22A is controlled by a switching control signal supplied from a control section 22B. The control section 22B receives a signal from the rotary encoder 17.

The switching section 22A receives an AC current from an AC power supply 23 and generates a direct current. The direct current is switched or chopped. It is, thereby converted to an excitation current. The excitation current will be supplied to the electromagnet units 19.

The excitation current has a pulse waveform and a frequency of (360°/number of poles of the rotor)×2. This current is supplied to each electromagnet unit.

Four electromagnet units 19 are provided. Their coils are connected as illustrated in FIG. 7.

The drive unit 22 is configured to perform two functions. First, it detects, from the output of the rotary encoder 17, that the permanent magnet units 18 have rotated to angle θ1 from the positions where their poles oppose those of the electromagnet units 19. Second, it supplies the excitation current to the electromagnet units 19 such that the poles of the units 19 magnetically repel the poles of the permanent magnet unit 18 by angle θ2, from angle θ1.

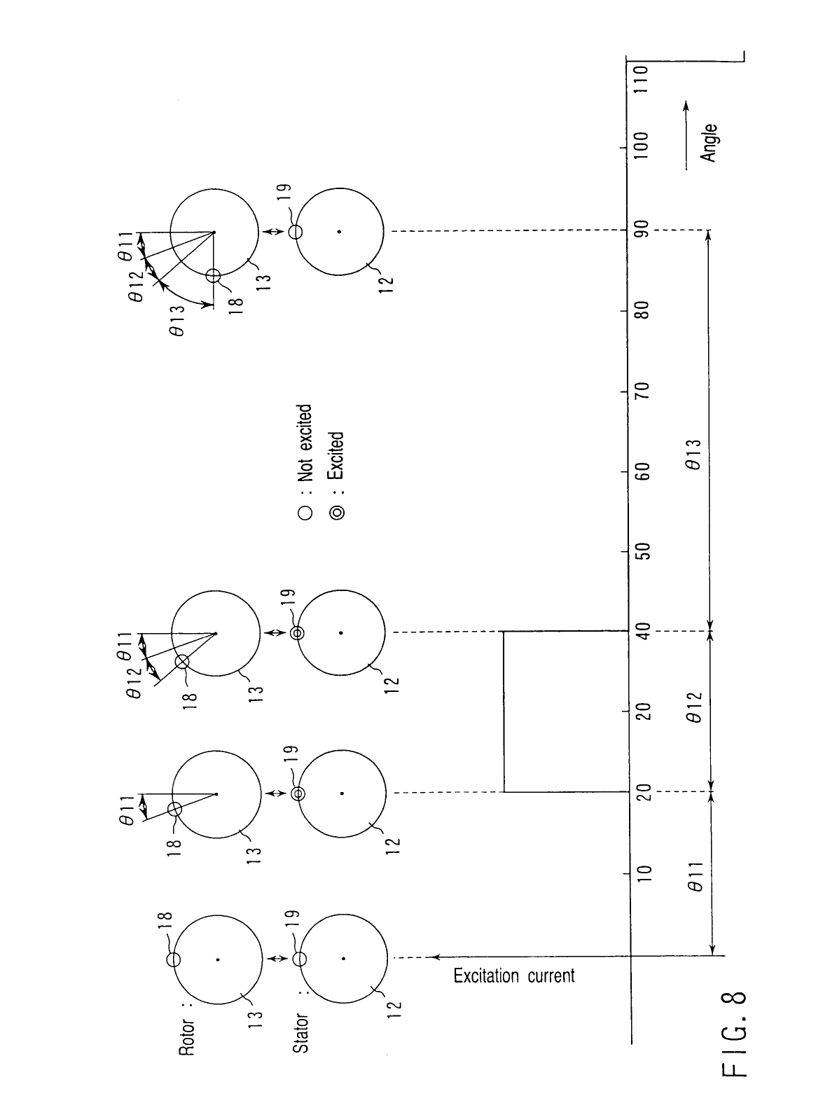

More specifically, the drive unit 22 supplies the excitation current to the electromagnet units 19 in accordance with the output of the rotary encoder 17. The excitation current has the frequency of 360° (=θ11+θ12+θ13)/number of poles of the rotor (=4, in this embodiment), as seen from FIG. 8. Here, θ11 is the period in which the electromagnet units 19 are close to the permanent magnet units 18 and the excitation current is not supplied to the units 19; θ12 is the period in which the excitation current is supplied to the units 19 and the magnetic field of each unit 19 repels the magnetic field of the permanent magnet unit 18; and θ13 is the period in which the excitation current is not supplied to the electromagnet units 19.

How the electromagnet units 19 are excited to rotate the rotor in a prescribed direction by 90° (=360°/4) will be described with reference to FIG. 8.

In FIG. 8, angle 0° defines the position where each permanent magnet unit 18 on the rotor lies most close to the electromagnet unit 19 on the stator. At this position, the magnetic-field center of the permanent magnet unit 18 and the magnetic-field center of the electromagnet unit 19 are most close to each other.

The time when the magnetic-field centers of the units 18 and 19 lie most close to each other is the starting point of the period θ11. No excitation current is supplied to the electromagnet unit 19 from the starting point to ending point of the period θ11. In this period, the magnetic force of only the permanent magnet unit 18 attracts the core (i.e., magnetic member) of the electromagnet unit 19.

The excitation current is supplied to the electromagnet unit 19 in the period θ12, or from the end of the period θ11, i.e., the starting point of the period θ12, to the end of the period 012.

Assume that the permanent magnet unit 18 is S pole. Then, the magnitude of the excitation current and the winding direction of the coil of the unit 19 are so set that the unit 19 may be S pole, too. The magnetic repulsion of the units 18 and 19 overcoming the magnetic attraction developed while no excitation current is supplied to the unit 19. It therefore rotates the permanent magnet 18 and the rotor frame 13 in a prescribed direction.

Next, the permanent magnet unit 18 on the rotor and the electromagnet unit 19 on the stator. No excitation current is supplied to the electromagnet unit 19 in the period θ13, or from the end of the period θ11, i.e., the starting point of the period θ13, to the end of the period θ13. In this period, the inertia of the flywheel 21 rotates the permanent magnet unit 18 and the rotor frame 13 in the prescribed direction.

In the above-described method of exciting the electromagnet units 19, the polarity of each electromagnet unit 19 is inverted every time the rotor rotates 90°. The permanent magnet units 18 and the rotor frame 13 are thereby rotated continuously in the prescribed direction.

In the excitation method depicted in FIG. 8, θ11, θ12 and θ13 are, for example, about 20°, about 20° and about 50°, respectively. In the period θ12 of applying the excitation current, the repulsion between the electromagnet unit 19 and the permanent magnet unit 18 rotates the rotor frame 13.

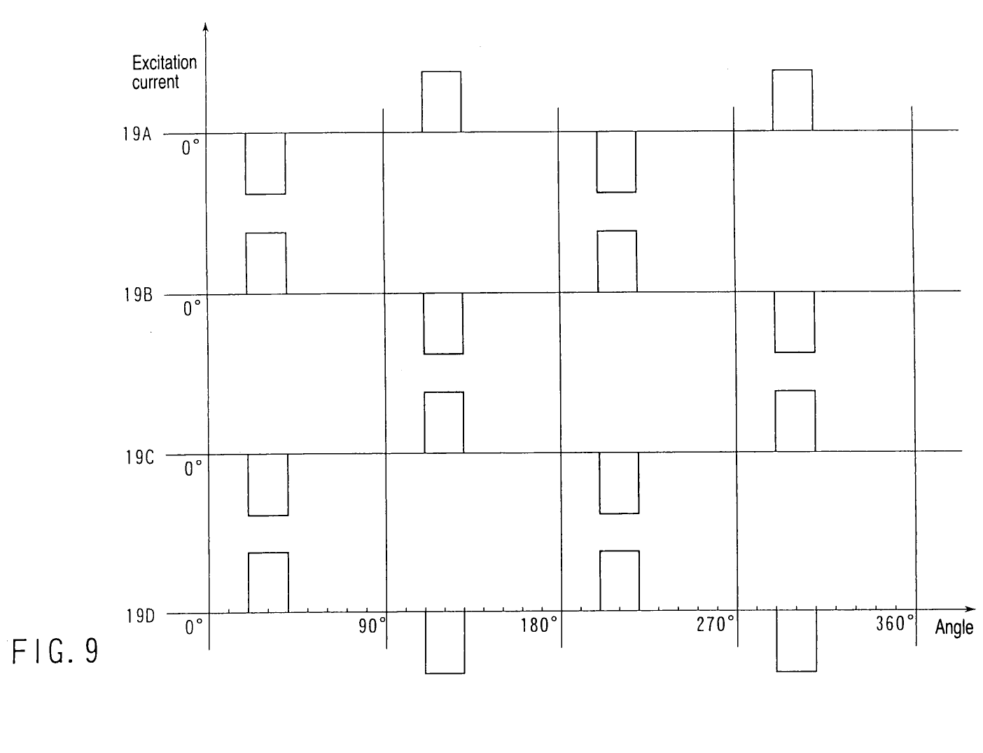

FIG. 9 shows when the timing of supplying the excitation current to the electromagnet units 19A, 19B, 19C and 19D. The rotor frame 13 can be rotated by electromagnetic repulsion, merely by supplying the excitation current to each electromagnet unit 19 during only the period θ12 that is a part of the time of 360°/number of rotor poles (i.e., four, in this embodiment) arranged in the circumferential direction. In addition, energy can be greatly saved because the rotor comprises permanent magnet units.

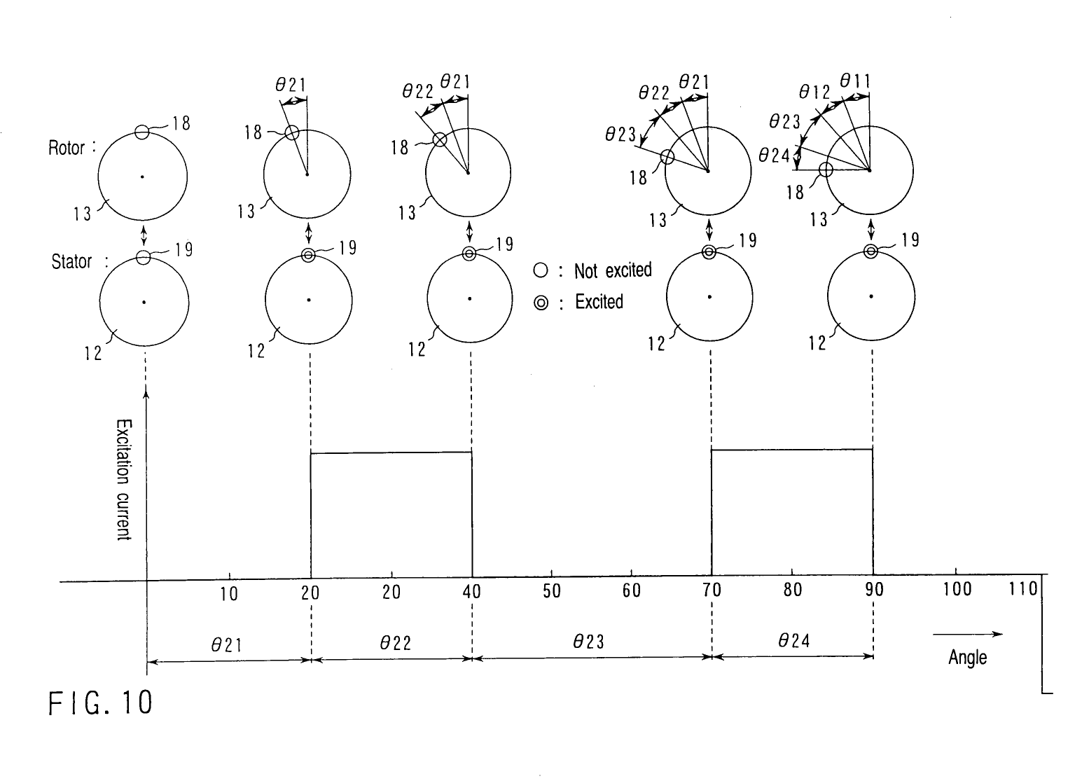

A method of exciting the electromagnet units 19, different from the method shown in FIG. 8, will be described with reference to FIG. 10. In the method of FIG. 8, each electromagnet unit 19 is excited so that its the magnetic field repels the magnetic field of the permanent magnet unit 18, to rotate the rotor frame 13.

In the method of FIG. 10, electromagnetic repulsion and electromagnetic attraction are applied to rotate the rotor frame 13. The excitation current is supplied to the electromagnet units 19 so that θ21+θ22+θ23+θ24=360/number of rotor poles arranged in the circumferential direction. Here, θ21 is the period in which the units 19 remain close to the permanent magnet units 18 and the excitation current is not supplied to the units 19; θ22 is the period in which the excitation current is supplied to the units 19, achieving electromagnetic repulsion; and θ23 is the period in which the excitation current is not supplied to the units 19; and θ23 is the period in which the excitation current is supplied to the units 19, causing electromagnetic attraction.

How the rotor is rotated by 90°=350°/4 (number of rotor poles) in the method of FIG. 10 will be explained. In the electric motor to which this method is applied, the permanent magnet units 18 arrange in the circumferential direction are alternately S pole and N pole.

In FIG. 10, the position where each permanent magnet unit 18 on the rotor lies most close to the electromagnet unit 19 on the stator is defined by angle 0°. At this position, the magnetic-field center of the permanent magnet unit 18 and the magnetic-field center of the electromagnet unit 19 are most close to each other. Assume that the period θ21 starts at this position. Then, no excitation current is supplied to the electromagnet units 19, from the starting point to ending point of the period θ21. Therefore, only the magnetic force of each permanent magnet unit 18 attracts the core, or magnetic member, of the electromagnet unit 19.

The permanent magnet units 18 on the rotor and the electromagnet unit 19 on the stator. From the start point of the period θ22, or the end of the period θ21, to the ending point of the period θ22, the excitation current is supplied to the electromagnet units 19.

Assume that the permanent magnet unit 18 are S poles. The magnitude of the excitation current and the winding direction of the coils of the units 19 are so set that the units 19 may be S pole, too.

Since the permanent magnet units 18 and the electromagnet units 19 are S poles, each permanent magnet unit 18 repels the opposing permanent magnet unit 18. The magnetic repulsion rotates the permanent magnets 18 and the rotor frame 13 in a prescribed direction. This is because the repulsion overcomes the magnetic attraction developed while no excitation current is supplied to the units 19.

Next, the permanent magnet unit 18 on the rotor and the electromagnet unit 19 on the stator. No excitation current is supplied to the electromagnet unit 19 in the period θ23, or from the end of the period θ21, i.e., the starting point of the period θ13, to the end of the period θ23. In this period, the inertia of the flywheel 21 rotates the permanent magnet unit 18 and the rotor frame 13 in the prescribed direction.

The permanent magnet unit 18 on the rotor and the electromagnet unit 19 on the stator. In the period θ24, that is, from the ending point of the period θ23, i.e., the starting point of the period θ24, to the ending point of the period θ24, the excitation current is supplied to the electromagnet units 19.

In this period, the next permanent magnet unit 18 and the next electromagnet unit 19 are an S pole and an N pole, respectively. Thus, electromagnetic attraction acts on the permanent magnet unit 18, rotating the permanent magnet unit 18 and the rotor frame 13 in the prescribed direction.

This excitation method is applied to each electromagnet unit 19, while changing the polarity thereof every 90°. It is therefore possible to rotate the permanent magnet units 18 and the rotor frame 13 continuously in one direction.

This excitation method can rotate the rotor frame 13 by virtue of electromagnetic repulsion and electromagnetic attraction, if the excitation current is supplied in only the period θ24 to achieve electromagnetic attraction.

In the excitation method of FIG. 10, θ21, θ22, θ23 and θ24 are, for example, 20°, 20°, 30° and 20°, respectively.

In the present invention, the electromagnet units are arranged on the stator frame in the radial direction, in one or more stages.

How the electromagnet units may be arranged in the embodiment described above will be explained. In this invention, the electromagnet units are arranged on the stator frame in the circumferential direction, spaced apart at equal distance or different distances, or some at equal distance and the others at different distances.

A case where the permanent magnet units are arranged in the circumferential direction will be described.

In the invention, the permanent magnet unit is arranged on the rotor frame in the circumferential direction, spaced apart at equal distance or different distances, or some at equal distance and the others at different distances. Thus, any two adjacent units may be of the same polarity or opposite polarities, or some units may have one polarity, while the others have the other polarity.

The permanent magnet units are arranged in the circumferential direction and also in the radial direction in one or more stages. Thus, any two adjacent units are of the same polarity or the opposite polarities, or some units have one polarity and the others have the opposite polarity.

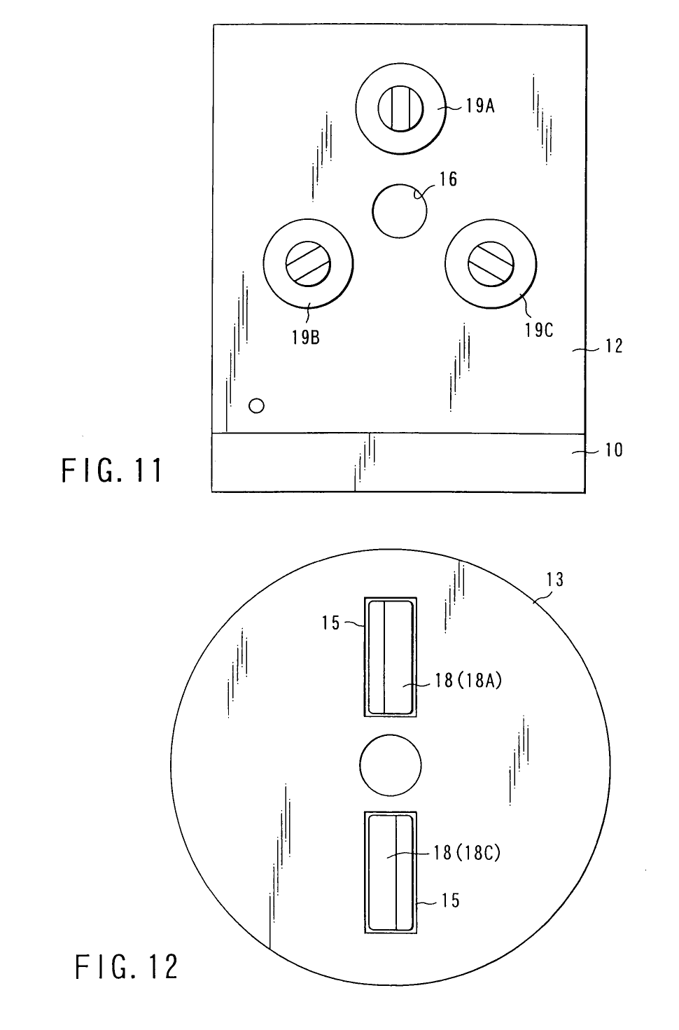

A stator which differs in structure from the one described above will be described, with reference to FIG. 11. As FIG. 11 shows, electromagnet units 19A, 19B and 19C are arranged in one stage and in the circumferential direction at regular intervals of 120°.

If the stator having this structure is employed, the period of supplying no excitation current and the period of supplying the excitation current are set, each for the 120°-rotation of the stator.

A rotor which differs in structure from the one described above will be described, with reference to FIG. 12. As FIG. 12 illustrates, permanent magnet units 18 (18A and 18B) are arranged in grooves 15, spaced apart by 180° in the circumferential direction. The adjacent poles of the units 18 are of the opposite polarities.

If this rotor is employed, the period of supplying no excitation current and the period of supplying the excitation current are set, each for the 180°-rotation of the stator, unlike in the case illustrated in FIGS. 8 to 10.

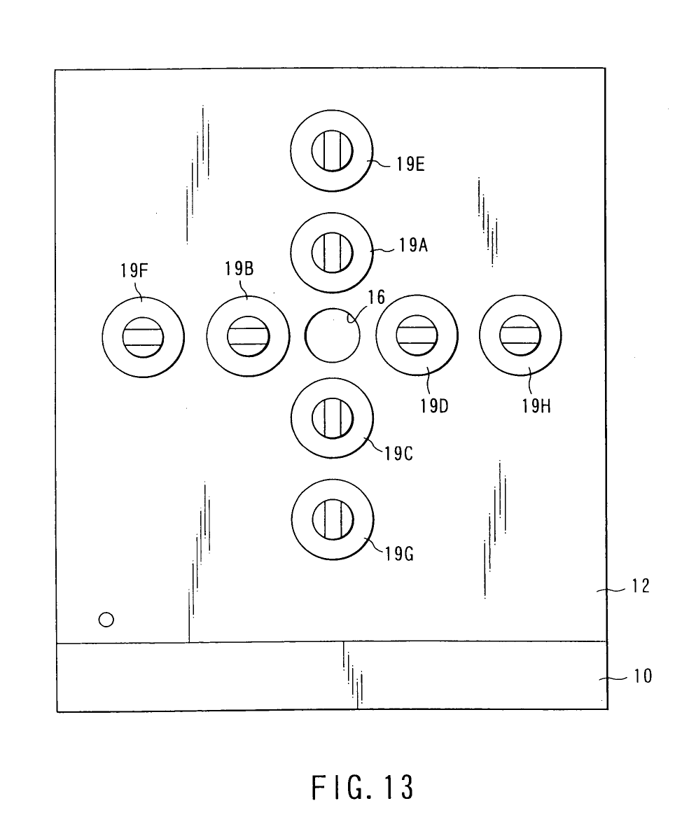

Another stator that differs in structure from the one described above will be described, with reference to FIG. 13. As FIG. 13 depicts, this stator has electromagnet units 19 (19A, 19B, 19C, 19D, 19E, 19F, 19G and 19H). The units 19 are arranged on the stator frame 12 in two stages in the radial direction. The four pairs of electromagnet units 19 are arranged in the circumferential direction at intervals of 90°.

The pair of electromagnet units 19A and 19E, the pair of electromagnet units 19B and 19F, the pair of electromagnet units 19C and 19G, and the pair of electromagnet units 19D and 19H are considered to correspond to the electromagnet units 19A, 19B, 19C and 19D shown in FIG. 3. Thus, the period of supplying no excitation current and the period of supplying the excitation current are set, each for the 90′-rotation of the stator, in the same way as in the case shown in FIGS. 8 to 10.

If the electromagnet units do not form four pairs, the current-supplying mode will of course differ from the mode shown in FIGS. 8 to 10. The period of supplying no excitation current and the period of supplying the excitation current will be set, each for the 90°-rotation of the stator.

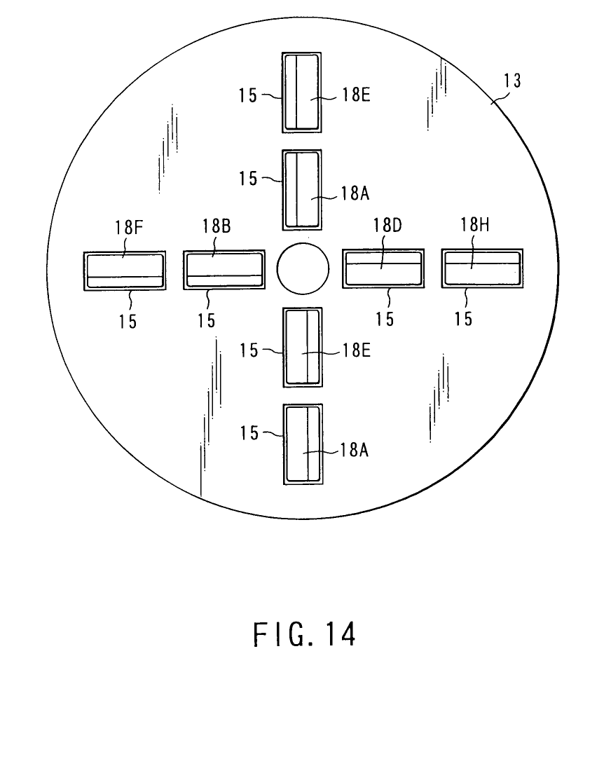

Another rotor, which differs in structure from the one described above, will be described, with reference to FIG. 14. As FIG. 14 shows, permanent magnet units 18 (18A, 18B, 18C, 18D, 18F, 18G and 18H) are arranged in grooves 15. They are spaced apart by 90° in the circumferential direction. These units 18 are arranged in two states in the radial direction. The adjacent poles of the units 18 are of the opposite polarities.

The pair of permanent magnet units 18A and 18E, the pair of permanent magnet units 18B and 18F, the pair of permanent magnet units 18C and 18G, and the pair of permanent magnet units 18D and 18H are considered to correspond to the permanent magnet units 18A, 18B, 18C and 18D shown in FIG. 3. Thus, the period of supplying no excitation current and the period of supplying the excitation current are set, each for the 90′-rotation of the rotor, in the same way as in the case shown in FIGS. 8 to 10. If the permanent magnet units do not form four pairs, the current-supplying mode will, of course, differ from the mode shown in FIGS. 8 to 10. The period of supplying no excitation current and the period of supplying the excitation current will be set, each for the 90′-rotation of the rotor.

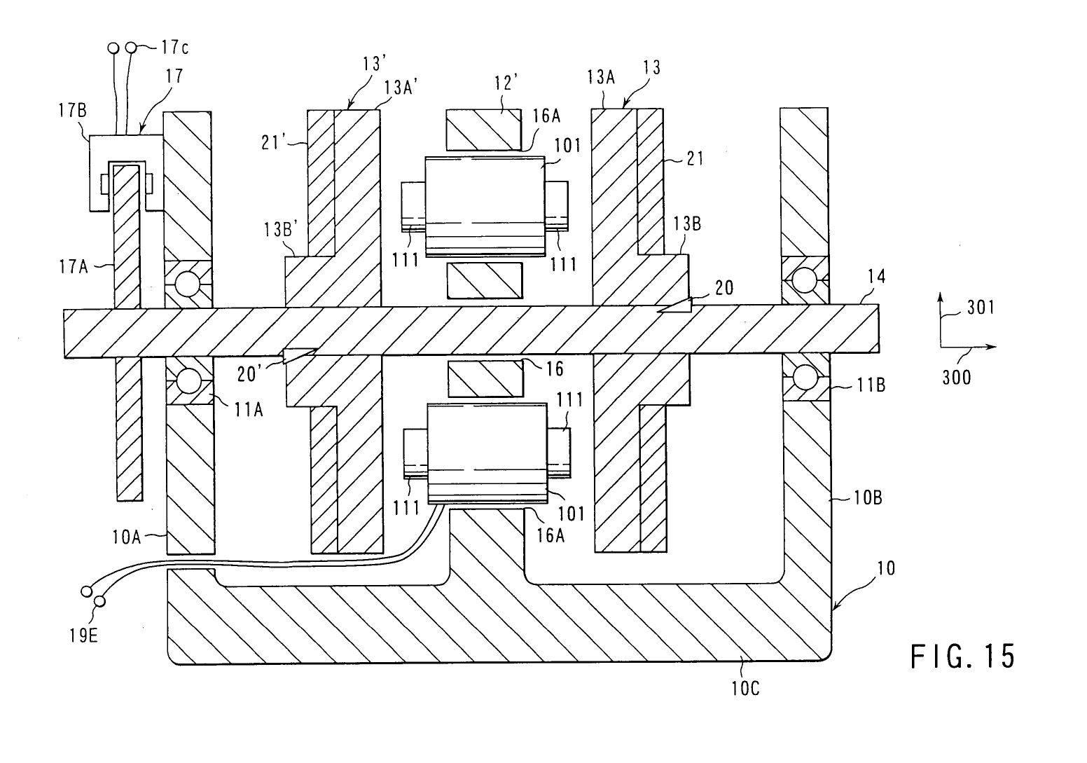

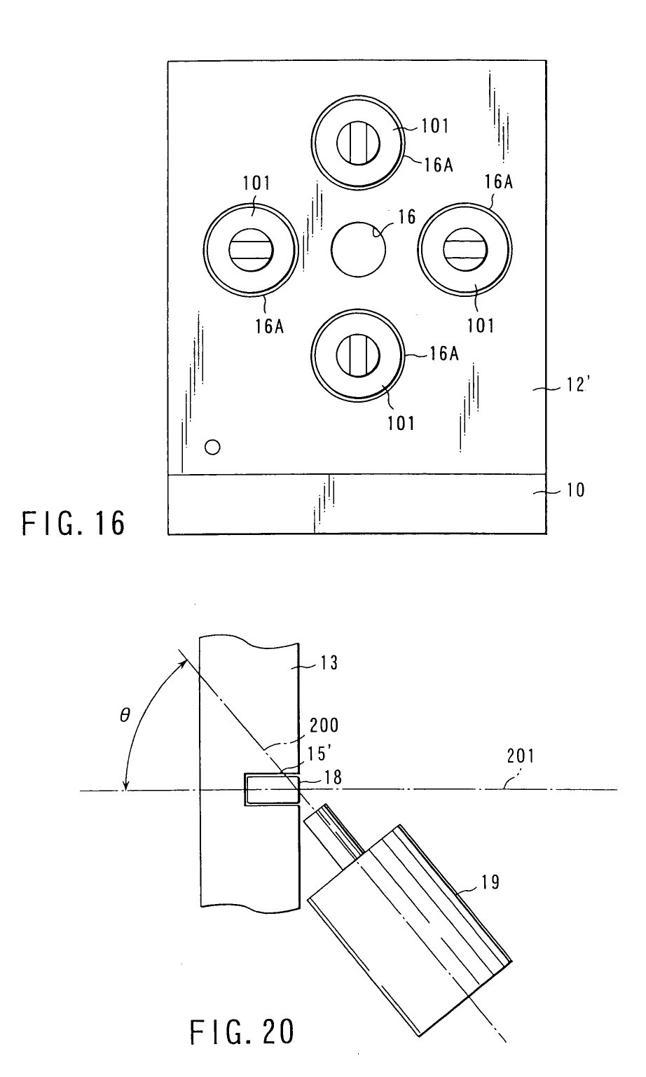

Another embodiment of an axial-gap motor according to this invention, which differs from the one shown in FIG. 1, will be described below with reference to FIGS. 15 and 16. The components identical to those shown in FIG. 1 are designated at the same reference numerals.

As seen from FIG. 15, the axial-gap motor according to this embodiment has a base 10. The base 10 comprises a first wall plate 10A, a second wall plate 10B, and a bottom plate 10C. The second wall 10B opposes the first wall plate 10A and spaced from the first wall plate 10A. The bottom plate 10C connects one end of the first wall plate 10A to one end of the second wall plate 10B.

The base 10 may be a single casting or may be a three-piece component. In the latter case, it is made by welding the first wall plate 10A, second wall plate 10B and bottom plate 10C together or fastening them together with screws.

The stationary part of the bearing 11A is held in the other end portion of the first wall plate 10A. The stationary part of the bearing 11B is held in the other end portion of the second wall plate 10A.

As FIG. 16 shows, the stator frame 12′ has a hole 16 made in the center part. It also has four holes 16A. A shaft 14 passes through the hole 16. The four holes 16A are made in the stator frame 12′. They are arranged in one stage in the radial direction and spaced apart at intervals of 90° in the circumferential direction. The stator frame 12′ can be a single casting or can be made by processing a plate. Note that the stator frame 12′ lies between two rotor frames 13 and 13′.

The electric motor has electromagnet units 101, which may be of the type shown in FIG. 17B. The unit 101 shown in FIG. 17B comprises an I-shaped core 111 and a coil 120 wound around the core 111. The ends of the I-shaped core 111 are used as magnetic poles.

The shaft 14 passes through the rotary part of the bearing 11A held in the first wall plate 10A and through the rotary part of the bearing 11B held in the second wall plate 10B.

The rotor frame 13 and 13′, which are similar to each other, are mounted on the shaft 14. The frames 13 and 13′ are spaced apart in the axial direction 300, with the stator frame 12′ located between them. A screw 20 is driven into the interface between the frame 13 and the shaft 14, securing the rotor frame 13 to the shaft 14. Similarly, a screw 20′ is driven into the interface between the frame 13′ and the shaft 14, fastening the rotor frame 13′ to the shaft 14.

Thus, the rotor frames 13 and 13′ oppose the stator frame 12, across axial gaps.

One end of the shaft 14 is the output shaft of the electric motor, as in the embodiment of FIG. 1. A rotary encoder 17, which is a sensor unit, is mounted on the other end of the shaft 14.

The rotary encoder 17 can detect the positional relation between the permanent electromagnet units 18 provided on the rotor frame 13, the permanent electromagnet units provided on the rotor frame 13′, and the electromagnet units 19. More specifically, it detects the rotational positions of the rotary frames 13 and 13′, and hence the relative positions of the magnetic poles of the permanent magnet units 18 provided on the rotor frames 13 and 13′.

In this embodiment, the permanent magnet units 18 provided on the rotor frames 13 and 13′, are arranged in the circumferential direction 302 and radial direction 301. They are so arranged that each has its one pole opposite in polarity to the adjacent pole of the next permanent magnet unit 18.

Flywheels 21 and 21′ are attached to the rotor frames 13 and 13′. The flywheels 21 and 21′ contribute to smooth rotation of the rotor frames. They may not be used. Nevertheless, they should better be used if the number of poles is small, in order to make the rotor frames rotate smoothly.

The magnetic-field centerline 200 of each electromagnet unit 19 intersects at angle θ with the magnetic-field centerline 201 of the permanent magnet unit 18.

In the present embodiment, the magnetic-field centerline of each electromagnet unit 19 aligns with the axis of the shaft 14. Note that “θ” is the position where the magnetic fields of the permanent magnet unit 18 and electromagnet unit 19 repel each other effectively. The inventors hereof set θ at, for example, 50°, as in the embodiment of FIG. 1.

In this embodiment, the rotor magnetic pole and the stator magnetic pole do not oppose each other and two rotors oppose each other, with one stator located between them. The electromagnet units 19 on the stator and the permanent magnet units on the two rotors cooperate to apply an electromagnetic force to the rotor efficiently. The embodiment can therefore be a high-efficiency electric motor.

Various electromagnet units that can be used in the embodiments described above will be described in detail, with reference to FIGS. 17A to 17E and FIGS. 18A and 18B.

The electromagnet unit 100 shown in FIG. 17A comprises an I-shaped core 110 and a coil 120 wound around the core 110. One end of the I-shaped core 110 is used as a magnetic pole. This electromagnet unit 100 can be used in the configuration of FIG. 1.

The electromagnet unit 101 shown in FIG. 17B comprises an I-shaped core 111 and a coil 120 wound around the core 111. The ends of the I-shaped core 110 are used as magnetic poles. The electromagnet unit 101 can be used in the configuration of FIG. 15.

The electromagnet unit 102 shown in FIG. 17C comprises two I-shaped cores 110 and two coils 120 wound around the cores 110, respectively. One end of the first I-shaped core 110 and one end of the second I-shaped core 110 are used as magnetic poles. These magnetic poles are opposite in polarity.

The electromagnet unit 103 shown in FIG. 17D comprises two I-shaped cores 110 and two coils 120 wound around the cores 110, respectively. One end of the first I-shaped core 110 and one end of the second I-shaped core 110 are used as magnetic poles. The magnetic poles have the same polarity.

The electromagnet unit 104 shown in FIG. 17E comprises two I-shaped cores 111 and two coils 120 wound around the cores 111, respectively. The ends of each I-shaped core 111 are used as magnetic poles.

The electromagnet unit 105 shown in FIG. 18A comprises a U-shaped core 112 and a coil 120 wound around the core 112. The ends of the U-shaped core 112 are used as magnetic poles.

The electromagnet unit 106 shown in FIG. 18B comprises two U-shaped cores 112 and two coils 120 wound around the cores 112, respectively. The ends of each U-shaped core 112 are used as magnetic poles.

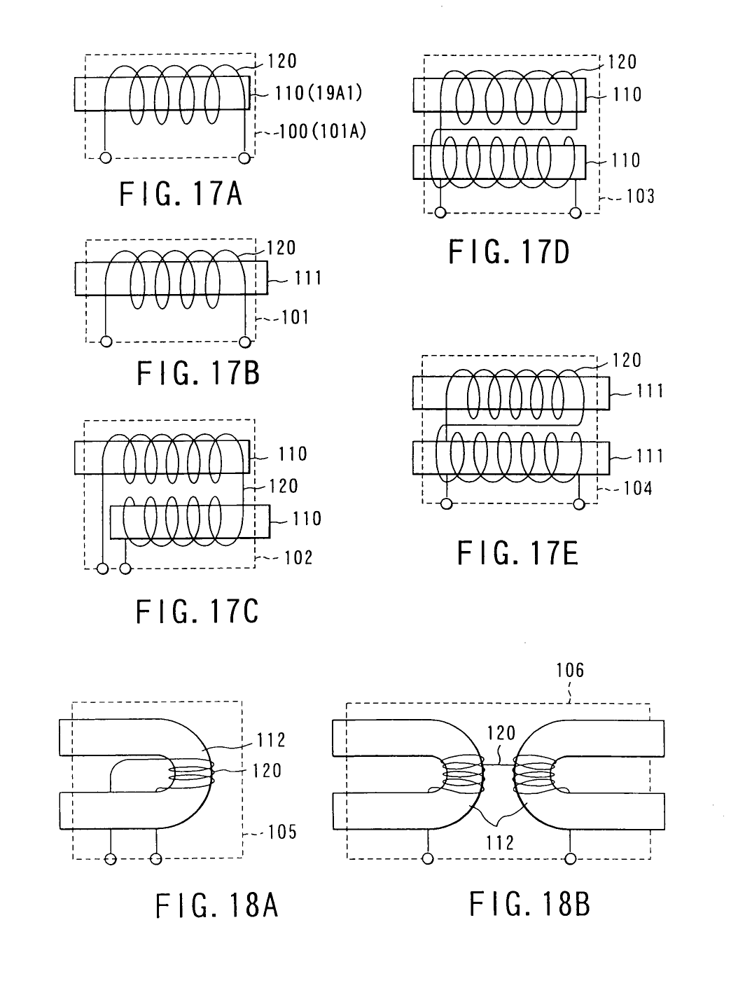

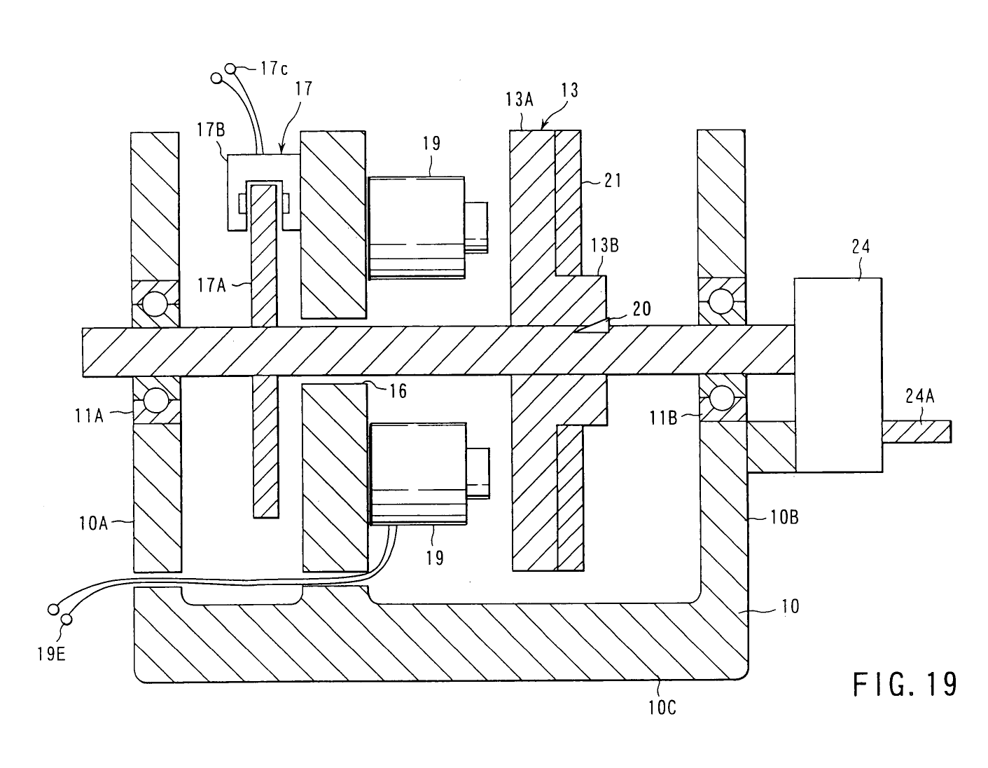

FIG. 19 shows an axial-gap motor in which a gearbox 24 coupled to the shaft 14 of the type shown in FIG. 1. This motor can provide a greater torque than the shaft 14.

The axial-gap motor of this embodiment has two rotation systems. The first system is concerned with the rotation of the rotor frame 13. The second system is concerned with the rotation of the output shaft 24A of the gearbox 24.

Fins may be provided on the rotor frame 13. If so, the rotor frame 13 will work as a high-speed, low-torque fan mechanism, and the output shaft 24A of the gearbox 24 will provide a low-speed, high-torque rotation mechanism.

In this embodiment, the magnetic-field centerline of each electromagnet unit 19 on the stator ant the magnetic-field centerline of the permanent magnet unit 18 on the rotor intersect at, for example, 50°. More precisely, the magnetic-field centerline that passes the magnetic pole center of the electromagnet unit 19 provided on the stator extends in the axial direction of the shaft 14.

With reference to FIG. 20 an axial-gap motor will be described, in which the magnetic-field centerline that passes the magnetic pole center of each permanent magnet unit 18 on the rotor extends in the axial direction of the shaft 14.

As FIG. 20 shows, grooves 15′ are made in the rotor frame 13. In the grooves 15′, permanent magnet units 18 are held. The magnetic-field centerline 201, which passes the magnetic pole center of each permanent magnet unit 18, extends in the axial direction of the shaft 14.

Electromagnet units 19 are secured to the stator frame such that the magnetic-field centerline 200 of each unit 19 intersects with the magnetic-field centerline 201 that passes the magnetic pole center of the permanent magnet unit 18.

This configuration can be applied to the electric motors illustrated in FIGS. 1 to 19, to attain the same advantages as the electric motors shown in FIGS. 1 to 19.

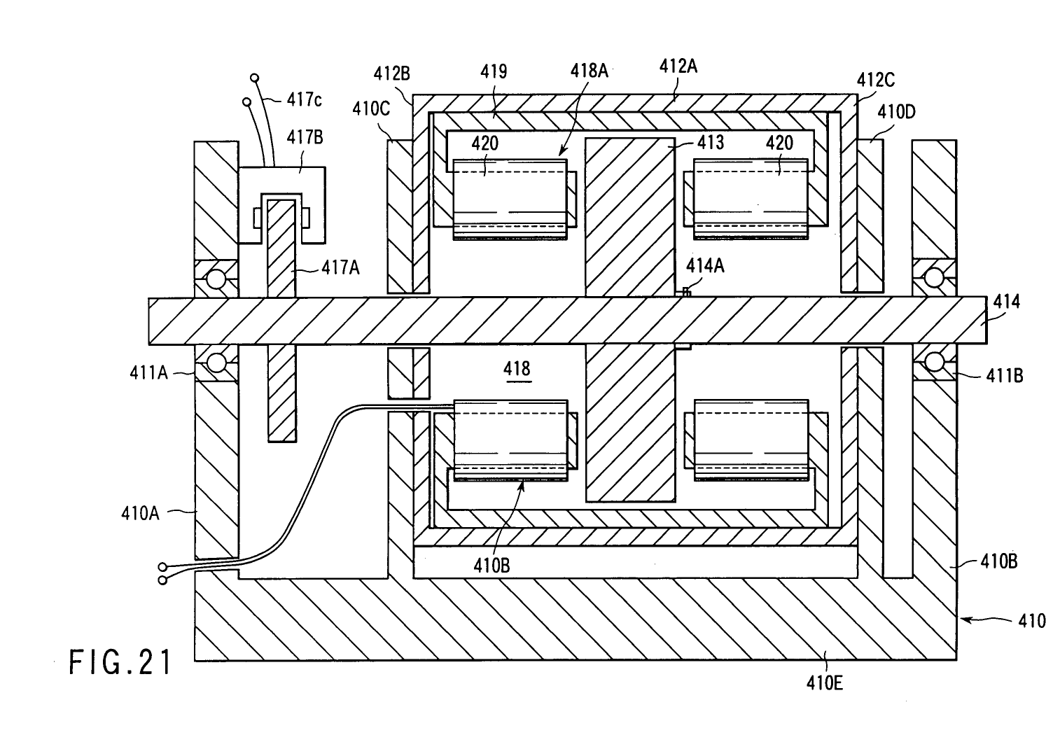

An axial-gap motor, which is another embodiment of the invention and differs from those shown in FIGS. 1, 15 and 19, will be described with reference to FIGS. 21 to 25.

FIG. 21 is a sectional view depicting an axial-gap motor that is another embodiment of the present invention.

The axial-gap motor according to this embodiment has a base 410. The base 410 comprises a first wall plate 410A, a second wall plate 410B, a third wall plate 410C, a fourth wall plate 410D, and a bottom plate 410E. The second wall 410B opposes the first wall plate 410A and spaced from the first wall plate 410A. The third wall plate 410C lies between the first and second wall plates 410A and 410G and opposes the first wall plate 410A. The fourth wall plate 410D opposes the second wall plate 410B. The bottom plate 410E connects the lower ends of the first, second, third and fourth wall plates 410A, 410B, 410C and 410D to one another.

The base 410 may be a single casting or may be a five-piece component. In the latter case, it is made by welding the first wall plate 410A, second wall plate 410B, third wall plate 410C and fourth wall plate 410D and the bottom plate 410E together or fastening them together with screws.

The stationary part of the bearing 411A is held in the other end portion of the first wall plate 410A. The stationary part of the bearing 411B is held in the other end portion of the second wall plate 410A. The third and fourth wall plates 410C and 410D have a hole each. A shaft 14 passes through the holes made in the wall plates 410C and 410D.

A stator frame 412 is provided between the third wall plate 410C and the fourth wall plate 410D and secured thereto by means of screws. The stator frame 412 comprises a support section 412A and end plates 412B and 412C. The support section 412A supports the yokes 419 of electromagnet units 418, which will be described later in detail. The end plates 412B and 412C have a hole each in the center part. The shaft 14 passes through the holes of the end plates 412B and 412C. The support section 412A may be a single casting or may be a three-piece component. In the latter case, it is made by welding the support section 412A and the end plates 412B and 412C together or fastening them together with screws.

As FIG. 21 shows, the shaft 414 passes through the rotary part of the bearing 411A held in the first wall plate 410A and through the rotary part of the bearing 411B held in the second wall plate 410B. The shaft 414 passes through the holes made in the third and fourth wall plates 410D and 410D, too.

As FIG. 21 shows, too, a rotor frame 413 is provided between the third and fourth wall plates 410C and 410D. A fastening member 414A secures the rotor frame 413 to the shaft 414. The rotor frame 413 contains permanent magnet units 416 (not shown in FIG. 21). The rotor frame 413 can be made, in part or in entirety, of titanium that is remarkably nonmagnetic metal. If the rotor frame 413 is made of titanium partly or entirely, the magnetic fluxes of the permanent magnet units 416 will leak but a little and will effectively act on the electromagnet units 418. Thus, the magnetic fluxes will contribute much to generation of rotation moment.

One end of the shaft 414 is the output shaft of the electric motor. The disc 417A of a rotary encoder 417, which is a sensor unit, is mounted on the other end of the shaft 414.

The rotary encoder 417 has a detecting section 417B. The detecting section 417B is attached to the first wall plate 410A. The rotary encoder 417 is designed to detect the positional relation between the permanent magnet units 418, on the one hand, and the electromagnet units 416, on the other. The rotary encoder 417 has a light-receiving/emitting element, which is incorporated in the detecting section 417B. The light-receiving/emitting element detects slits or light-reflecting members provided in or on the disk 417A. The rotary encoder 417 outputs an electric signal to a read line 417C. The sensor unit may be other than the optical rotary encoder. It may be, for example, a Hall element. If this is the case, the sensor unit can magnetically detect the positions the permanent magnet units 416 take relative to the electromagnet units 418.

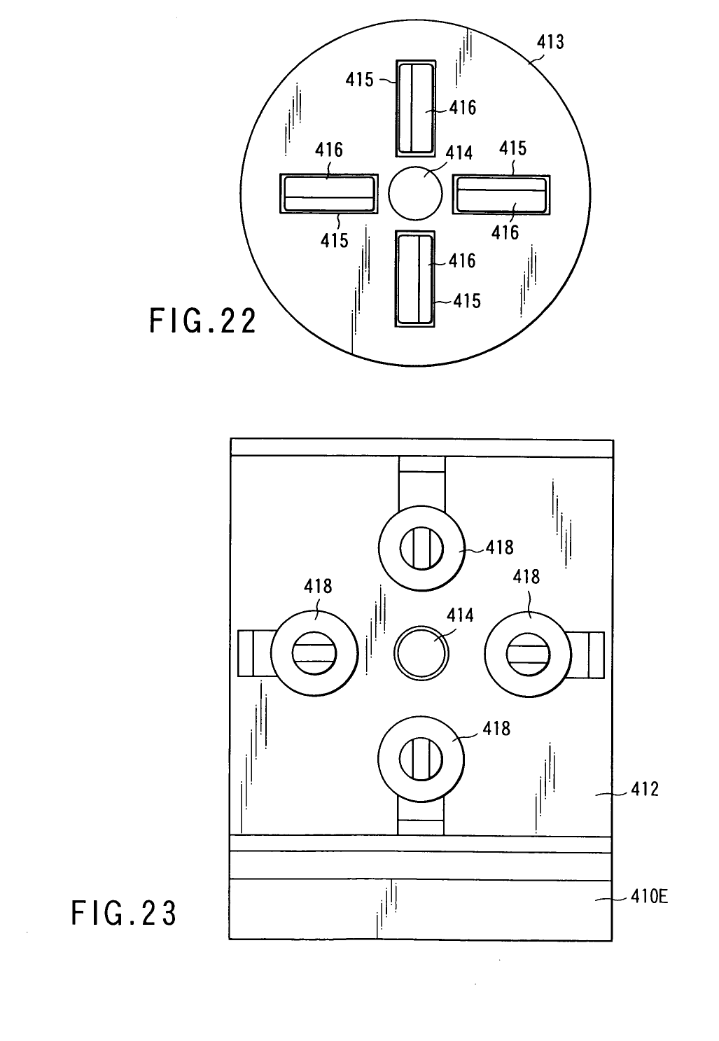

In this embodiment, four permanent magnet units 416 are provided in each side of the rotor frame 413, which opposes the electromagnet units 413. They are arranged in the circumferential direction at intervals of 90° (=360°/4). More precisely, as illustrated in FIG. 22 that shows one side of he rotor frame 413, grooves 415 are made in each side of the rotor frame 413. Diamond-shaped permanent magnets, for example, are held in the grooves 415.

Note that the permanent magnet units 416 are arranged on the sides of the rotary frame 413 such that any two adjacent units on each side or both sides are of the same polarity or the opposite polarities.

As mentioned above, the permanent magnet units 416 are held in the grooves 415. They may be secured to the rotor frame 413 by various methods, for example by using screws or resin.

The grooves 415 made in the rotor frame 413 may be so shaped to embed the permanent magnet unit 416 completely, thus preventing the same from slipping out.

A mechanism may be used to change the orientation of each permanent magnet unit 416 held in one groove 415. If so changed in orientation, the permanent magnet units 416 will take such positions that an electromagnetic repulsion will effectively act in the electric motor according to the present embodiment.

The permanent magnet units 18 held in the grooves 15 may differ in shape. In this case, the electromagnetic repulsion can effectively work in the electric motor according to present embodiment.

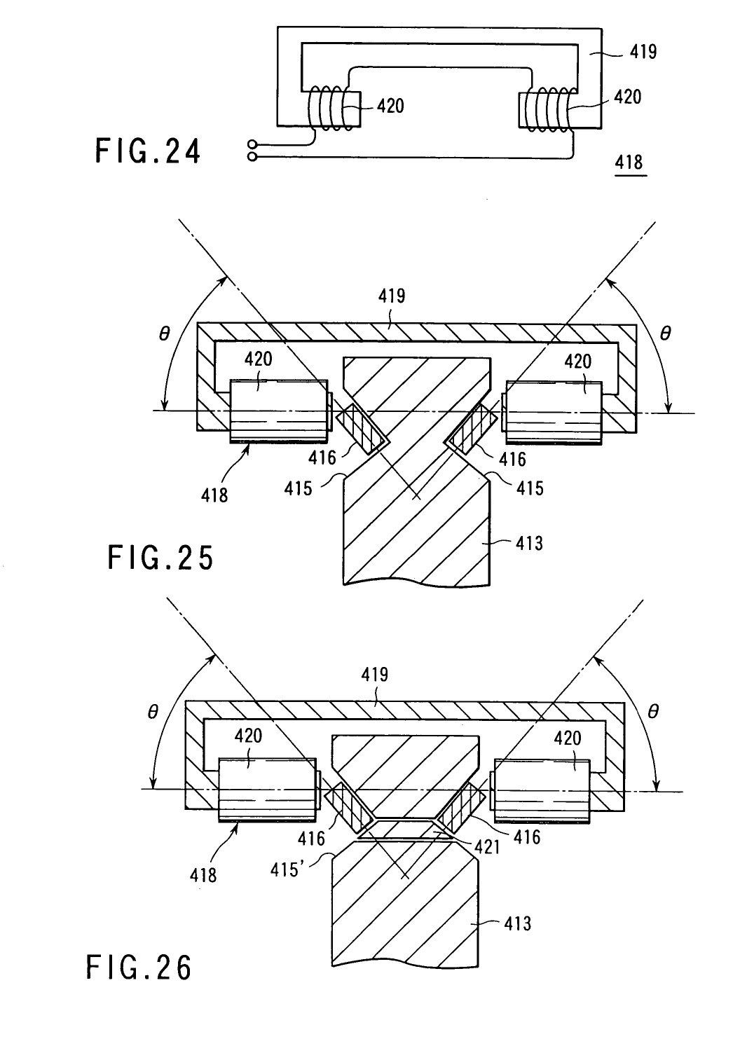

In this embodiment, two sets of electromagnet units 418 are provided in the stator frame 412. Each set consists of four units 418 that are arranged in the circumferential direction at intervals of 90° (=360°/4). To be more specific, four electromagnet units 418 are so positioned that their magnetic poles oppose the permanent magnet units 416 provided on the rotor frame 413, as seen from FIG. 23 that shows one side of the stator frame 412. As FIGS. 21 and 24 depict, any two electromagnet units 418 opposing across the stator frame 412 comprise a C-shaped yoke 419 and two coils 420. The yoke 491 has a gap in which one permanent magnet unit 416 may lie. The coils 420 are wound around the end portions of the yoke 419, respectively.

The positional relation between the permanent magnet units 416 on the rotor, on the one hand, and the electromagnet units 418 on the stator, on the other hand, will be described with reference to FIG. 25. As FIG. 25 shows, the magnetic-field centerline of any permanent magnet unit 416 provided on the stator intersects at angle θ with the magnetic-field centerline of one electromagnet unit 418.

In this case, the magnetic-field centerlines of electromagnet units 418A1 and 418A2 align with the axis of the shaft 414. Note that “θ” is the position where the magnetic fields of the permanent magnet unit 416 and electromagnet unit 418 repel each other effectively. The inventors hereof set θ at, for example, 50°.

The electric circuit incorporated in the axial-gap motor according to this embodiment is the same as the circuit illustrated in FIG. 6. The excitation current supplied to the electromagnet units 418 are identical to the current used in the circuit of FIG. 6. The excitation current has a pulse waveform and a frequency of (360°/number of poles of the rotor). This current is supplied to each electromagnet unit.

In the axial-gap motor according to this embodiment, the electromagnet units 418 and the permanent magnet units 416 are arranged so that the magnetic-field centerline of each electromagnet unit may intersects at angle θ with that of the corresponding permanent magnet unit 416. And the excitation current is supplied to the electromagnet unit 418 to make the unit 418 magnetically repels the permanent magnet unit 416, rotating the unit 416 by a certain angle from the position where its magnetic pole opposes that of the electromagnet unit 416 and further by a prescribed.

The rotor frame 413 holding the permanent magnet units 416 lies in the gap between two sets of electromagnet units 418, each having two magnetic poles that are opposite in polarity. Hence, the magnetic force of each permanent magnet unit 416 and that of the electromagnet unit 418 efficiently repel each other. The embodiment can therefore be a high-efficiency electric motor.

A modified rotor section will be described with reference to FIG. 26. In FIG. 26, the components identical to those shown in FIG. 25 are designated at the same reference numerals. As FIG. 26 shows, the rotor frame 413 has grooves 415′. In the grooves 415′, permanent magnet units 421 are arranged in the axial direction, too.

The permanent magnet units 421 and the permanent magnet units 416 on both sides of the rotor frame 413 constitute magnetic paths. This makes the magnetic force of the rotor frame 413 effectively act on the electromagnet units 418 provided on the stator. This embodiment can therefore be a high-efficiency electric motor.

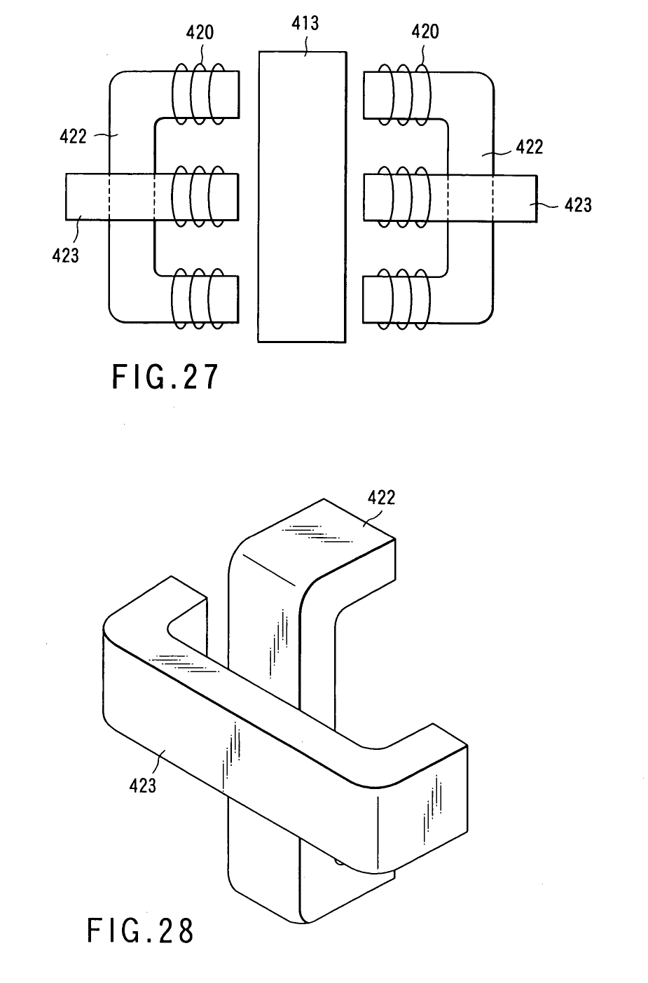

Electromagnet units of another type will be described with reference to FIGS. 27 to 30.

FIG. 27 shows two electromagnet units, and FIG. 28 shows one of them. Each unit comprises four coils 420 and two C-shaped yokes 422 and 423 each having two magnetic poles. Two coils 420 are wound around the magnetic poles of one yoke 422. Similarly, two coils 420 are wound around the magnetic poles of the other yoke 423. The two electromagnet units are arranged on the sides of the rotor frame 413, respectively, such that the magnetic poles of one unit oppose those of the other unit.

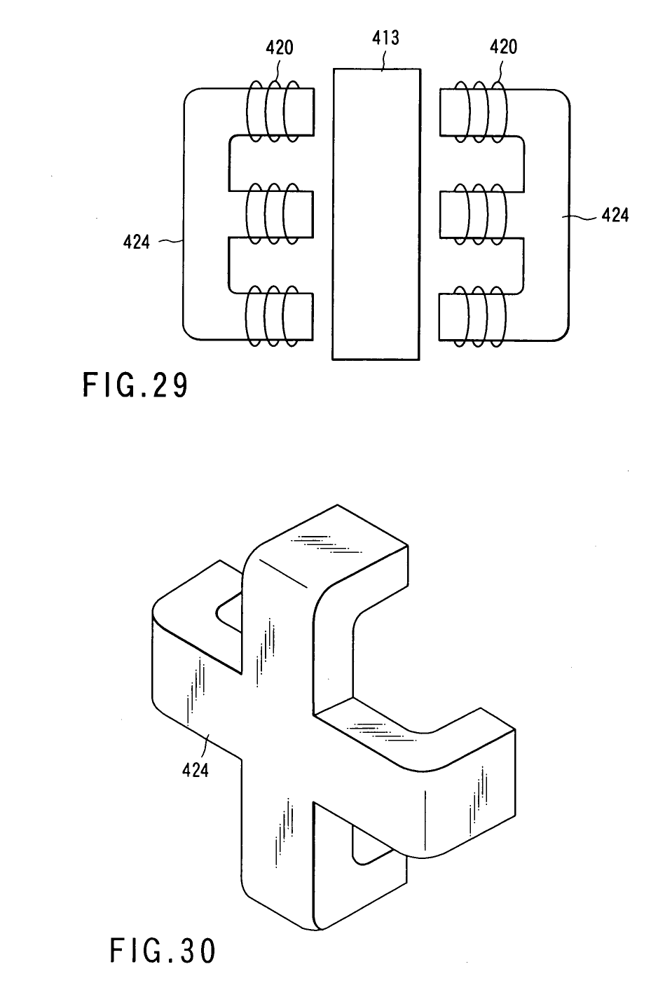

FIG. 29 shows two electromagnet units, and FIG. 30 shows one of them. Each electromagnet unit comprises four coils 420 and one yoke 424 having four magnetic poles. Four coils 420 are wound around the four magnetic poles of the yoke 424. The two electromagnet units are arranged on the sides of the rotor frame 413, respectively, such that the magnetic poles of one unit oppose those of the other unit.

The electromagnet units of FIGS. 27 and 28 can constitute a magnetic circuit from which magnetism scarcely leaks. So can the electromagnetic units of FIGS. 29 and 30. These electromagnetic units serve to provide high-efficiency electric motors.

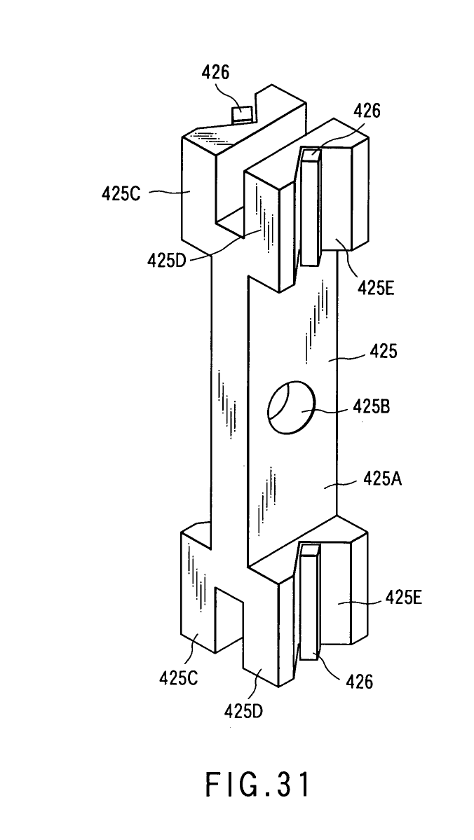

A rotor frame 425 and permanent magnet units 426, different from those described thus far, will be described with reference to FIG. 31.

As FIG. 31 depicts, the rotor frame 425 comprises a rotor bar 425A and U-shaped parts formed integral with the ends of the bar 425A. The rotor bar 425A has a hole made in the middle part. The hole allows passage of a shaft (not shown). Each U-shaped part comprises two legs 425B and 425C. The legs 425B and 425C have a groove 425E each, made in that side which opposes an electromagnet unit (not shown). Two permanent magnet units 426 are held in the grooves 425E of each U-shaped part.

The electromagnet units and the permanent magnet units 426, all shown in FIG. 31, are secured in the same manner as those shown in FIGS. 25 and 26. The grooves 425E may have any shape that is desirable in view of the shape of the permanent magnet units 426. The units 426 may be secured to the rotor frame 425 by various methods, for example by using screws or resin.

Thus constructed, the rotor frame 425 can help to provide a lightweight two-pole rotor.

The present invention is not limited to the embodiments described above. Various changes and modifications can be made without departing from the scope and spirit of the invention.

With regard to the permanent magnet units on the rotor, the number of poles they have and the arrangement of the poles in the circumferential and radial direction can be selected on the basis of the number of poles provided on the stator and the like.

With regard to the electromagnet units on the stator, the number of poles they have and the arrangement of the poles in the circumferential and radial direction can be selected on the basis of the number of poles provided on the rotor and the like.

The permanent magnet units and electromagnet units can have various structures and shapes. The coils can be connected in various ways, provided that they generate such magnetic repulsion and attraction as desired in the present invention.

Further, the above-described embodiments may be combined in whichever way possible. Any combination of the embodiments can attain the advantages of the embodiments.

Moreover, the embodiments include various phases of the invention. The components disclosed herein may be combined in various ways to make various inventions.

For example, an invention may be made if some components of any embodiment described above are not used. In this case, the known techniques shall be employed to make up for the components not used.

As indicated above, the present invention provides an axial-gap motor that comprises:

a stator frame;

a plurality of electromagnet units which are arranged on the stator frame;

a rotor frame which is spaced apart from the stator frame by a predetermined distance;

a plurality of permanent magnet units which are provided on the rotor frame, which oppose the electromagnet units across an axial gap and each of which has a magnetic-field centerline that intersects with a magnetic-field centerline of the electromagnet unit as viewed in a radial direction;

a sensor unit which detects a positional relation of the electromagnet units and permanent magnet units; and

a drive unit which detects, from an output of the sensor unit, that each of the permanent magnet units has rotated by a predetermined angle from the position where magnetic poles of the permanent magnet units substantially opposes magnetic poles of the electromagnet units and which supplies an excitation current to the electromagnet units, so as to repulse the magnetic poles of the permanent magnet units and the magnetic poles of the electromagnet units to repel and rotate the permanent magnet units, through the predetermined prescribed angle.

In the electric motor thus configured, the electromagnet units and the permanent magnet units are so arranged that the magnetic-field centerline of each electromagnet unit intersects at the predetermined angle with the magnetic-field centerline of one permanent magnet unit. Hence, each permanent magnet unit is rotated by a predetermined angle from the position where the magnetic poles of the permanent magnet units substantially opposes that of the electromagnet units. The excitation current is then supplied to the electromagnet units. The magnetic poles of the electromagnet units therefore repel and rotate the permanent magnet units through a prescribed angle.

With the present invention it is therefore possible to rotate the permanent magnet units and the rotor frame with a current smaller than otherwise. The invention can provide an axial-gap motor that has good characteristics in view of energy saving.

What is claimed is:

1. An axial-gap motor comprising:
a stator frame;
a plurality of electromagnet units which are arranged on the stator frame;
a rotor frame which is spaced apart from the stator frame by a predetermined distance;
a plurality of permanent magnet units which are provided on the rotor frame, which oppose the electromagnet units across an axial gap and each of which has a magnetic-field centerline that intersects with a magnetic-field centerline of the electromagnet unit as viewed in a radial direction;
a sensor unit which detects a positional relation of the electromagnet units and permanent magnet units; and
a drive unit which detects, from an output of the sensor unit, that each of the permanent magnet units has rotated by a predetermined angle from the position where magnetic poles of the permanent magnet units substantially opposes magnetic poles of the electromagnet units and which supplies an excitation current to the electromagnet units, so as to repulse the magnetic poles of the permanent magnet units and the magnetic poles of the electromagnet units, through the predetermined angle.

2. The axial-gap motor according to claim 1, wherein θ11+θ12+θ13)/number of poles of the rotor=360°, the drive unit comprises means for supplying the excitation current to the electromagnet units in accordance with the output of the sensor unit such that θ11 is a period in which the permanent magnet units remain close to the electromagnet units and the excitation current is not supplied, θ12 is a period in which the magnetic fields of the electromagnet units repel the magnetic fields of the permanent magnet units and the excitation current is supplied, and θ13 is a period in which the excitation current is not supplied.

3. The axial-gap motor according to claim 1, wherein θ21+θ22+θ23+θ24)/number of poles of the rotor=360°, the drive unit comprises means for supplying the excitation current to the electromagnet units in accordance with the output of the sensor unit such that θ21 is a period in which the permanent magnet units remain close to the electromagnet units and the excitation current is not supplied, θ22 is a period in which the electromagnet units magnetically repel the permanent magnet units and the excitation current is supplied, θ23 is a period in which the excitation current is not supplied, and θ24 is a period in which the electromagnet units magnetically attract the permanent magnet units and the excitation current is supplied.

4. The axial-gap motor according to claim 1, wherein each of the electromagnet units has a magnetic-pole surface each which is orientated in an axial direction.

5. The axial-gap motor according to claim 1, wherein the electromagnet units are arranged on the stator frame and spaced apart at regular intervals, irregular intervals, or regular and irregular intervals in a circumferential direction.

6. The axial-gap motor according to claim 1, wherein the electromagnet units are arranged on the stator frame in one or more stages in the radial direction.

7. The axial-gap motor according to claim 1, wherein each of the electromagnet units comprises at least one of an I-shaped core and a U-shaped core and a coil wound around said at least one of the cores.

8. The axial-gap motor according to claim 1, wherein each of the electromagnet units comprises a C-shaped yoke having a gap in which one permanent magnet unit on the rotor frame is arranged, and coils wound around the end portions of the yoke, respectively.

9. The axial-gap motor according to claim 1, wherein each of the electromagnet units comprises a plurality of C-shaped yokes provided on one side of the stator frame and straddling one permanent magnet unit on the rotor frame, a plurality of C-shaped yokes provided on the other side of the rotor frame and straddling the permanent magnet unit on the rotor frame, and coils wound around end portions of each of these yokes.

10. The axial-gap motor according to claim 1, wherein each of the electromagnet units comprises a first yoke arranged on one side of the stator frame, straddling one permanent magnet unit on the rotor frame and having one end opposing the permanent magnet unit on the stator frame, and a second yoke arranged on the other side of the stator frame, straddling the permanent magnet unit on the rotor frame and having one end opposing the permanent magnet unit on the stator frame.

11. The axial-gap motor according to claim 1, wherein the rotor frame has a wall opposing the stator frame and a plurality of grooves made in the wall, extending in the radial direction and provided for holding the permanent magnet units.

12. The axial-gap motor according to claim 1, wherein each of the permanent magnet units has a magnetic-pole surface which is orientated in an axial direction.

13. The axial-gap motor according to claim 1, wherein the permanent magnets are arranged on the rotor frame in a circumferential direction, with adjacent magnetic poles having the same polarity, different polarity or the same polarity and different polarities and spaced apart at regular intervals, irregular intervals or regular and irregular intervals.

14. The axial-gap motor according to claim 1, wherein the permanent magnets are arranged on the rotor frame in a circumferential direction and in one or more stages, with adjacent magnetic poles having the same polarity, different polarity or the same polarity and different polarities.

15. The axial-gap motor according to claim 1, wherein some of the permanent magnet units are arranged on one wall of the rotor frame, which extends in the axial direction, and the remaining permanent magnet units are arranged on the other wall of the rotor frame, which extends in the axial direction.

16. The axial-gap motor according to claim 1, wherein each of the permanent magnet units comprises a first permanent magnet piece arranged on one wall of the rotor frame, which extends in the axial direction, a second permanent magnet piece arranged on the other wall of the rotor frame, which extends in the axial direction, and a third permanent magnet piece arranged between the first and second permanent magnet pieces.

17. The axial-gap motor according to claim 1, wherein at least one part of the rotor frame on which the permanent magnet units are provided is made of titanium.

18. The axial-gap motor according to claim 1, wherein another rotor frame is provided on that side of the stator frame which faces away from said rotor frame, and other electromagnet units are arranged on the other rotor frame and spaced apart from the permanent magnet units across a predetermined axial gap.

19. The axial-gap motor according to claim 1, further comprising:
a shaft which is coupled to the rotor frame;
bearings which support the shaft; and
a base in which the bearing are provided.

20. The axial-gap motor according to claim 1 or 18, wherein a flywheel is arranged on the rotor frame.

21. The axial-gap motor according to claim 1 or 18, wherein a mechanism is provided to combine the rotor frame and the shaft together and separate the rotor frame and the shaft from each other.

22. The axial-gap motor according to claim 20, further comprising a gearbox which change a rotational speed of the shaft.
